(19) United States
(12) Patent Application Publication
(10) Pub. No.: US 2008/0005382 A1
(43) Pub. Date: Jan. 3, 2008

(54) System and method for resource allocation in fault tolerant storage system

(75) Inventor: Yasuyuki Mimatsu, Cupertino, CA (US)

Correspondence Address: SUGHRUE MION, PLLC, 401 Castro Street, Ste 220, Mountain View, CA, 94041-2007, US

(73) Assignee: HITACHI, LTD., Tokyo (JP)

(21) Appl. No.: 11/454,061

(22) Filed: Jun. 14, 2006

(51) Int. Cl. G06F 3/00

(52) U.S. Cl. 710/19

(57) ABSTRACT

Storage system keeps tracks of the state of each physical resource (e.g., disk drive) and logical resource (e.g., RAID group). Healthy resources are preferentially used to increase reliability and availability of data in the storage system. Specifically, when an administrator makes an operation, which requires the use of a resources in the storage system, for example, assigns a LU (Logical Unit) to a host computer, the storage system preferentially uses resources, which have fewer failures. Furthermore, if a storage system detects that a resource's state becomes degraded, the system attempts to replace the degraded resource with other resources, which have fewer failures before the degraded resource completely fails.

### DESCRIPTION OF THE INVENTION

1. Field of the Invention

This invention generally relates to managing storage system, and, more specifically, to increasing the reliability, availability and performance of storage systems.

2. Description of the Related Art

RAID (Redundant Array of Inexpensive Disks) storage systems are well known to persons of skill in the art and are widely used in the industry. In a RAID system, multiple disk drives are organized as one RAID storage group. In a RAID system, data is stored with error correction code and is distributed among separate disk drives of the RAID group. If a disk drive in a RAID group fails, RAID controller reads data from other disk drives and is capable of rebuilding the data in the failed disk drive by using error correction code. For this reason, RAID systems provide high data storage reliability and availability against a disk drive failure.

Advanced RAID systems additionally provide redundant data paths to each disk drive. Usually, there are two data paths to each disk drive such that the disk drive can still be accessed even if one path becomes unavailable. Each disk drive also provides redundancy by itself. If a few sectors of the drive become unavailable, data stored in those sectors are reallocated to spare sectors and the drive continues to work.

As described above, there are various redundancies in the RAID system. They all collectively improve the ability of the overall storage system to tolerate failure. Some of the storage system components such as disk drives or paths to the drives incorporate redundancy and can continue to operate in degraded state even when certain types of failures occur. However, it is desirable to replace the degraded components by fully functional components before they an unrecoverable failure occurs and data stored therein becomes unavailable.

Therefore, what is needed is a system and method, which preferentially uses resources that have fewer failures and provides for replacement of degraded resources by more healthy resources.

### SUMMARY OF THE INVENTION

The inventive methodology is directed to methods and systems that substantially obviate one or more of the above and other problems associated with conventional techniques for storage resource allocation.

In accordance with an embodiment of the inventive technique, there is provided a method for selecting resources for inclusion into a resource group. The inventive embodiment involves receiving information from a user on an amount of required resources and determining whether the required amount of resources having a good status is available. If the required amount of resources having the good status is available, the required amount of resources having the good status are selected. If the required amount of resources having the good status is not available, the method involves verifying whether the required amount of resources having either the good or a degraded status is available. If the required amount of resources having either the good or the degraded status is available, the inventive method involves selecting all resources having the good status and an additional amount of resources having the degraded status and including the selected resources to the resource group.

In accordance with another embodiment of the inventive technique, there is provided a computerized storage system. The inventive computerized storage system includes a host computer; a disk array system coupled to the host computer via a network, and hosting at least one logical unit accessible by the host computer. The disk array system includes at least one storage disk drive, at least two disk drive controllers, each connected to the at least one disk drive, and a management server including a management console. The management server is configured to receive storage system management instructions from an administrator and further configured to execute a management program. The disk array system further includes a memory unit storing a storage control program, a disk drive table containing information on the at least one storage disk drive, RAID group table containing information on RAID groups and a LU table containing information about the at least one logical unit. The disk array system further includes a central processing unit operable to execute the storage control program. The storage control program processes input/output requests sent from the host computer, determines the status of the at least one storage disk drive, allocates the at least one disk drives to a RAID group and communicates with the management console.

In accordance with yet another embodiment of the inventive technique, there is provided a computerized storage system including a host computer, a disk array system coupled to the host computer via a network, and hosting at least one logical unit accessible by the host computer. The disk array system includes at least one storage disk drive, at least two disk drive controllers, each connected to the disk drive and a management server including a management console. The management server receives storage system management instructions from an administrator and executes a management program. The disk array system further includes a memory unit storing a storage control program, a disk drive table including information on the at least one storage disk drive, RAID group table including information on RAID groups and a LU table including information about the at least one logical unit. The disk array system further includes a central processing unit executing the storage control program. The storage control program processes input/output requests sent from the host computer, determines the status of resources, allocates resources to at least one resource group and communicates with the management console.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 provides an overview of a computer storage system, which may be used to implement an embodiment of the inventive technique.

FIG. 2 illustrates an exemplary embodiment of a Disk Drive Table.

FIG. 3 illustrates an exemplary embodiment of a RAID Group Table.

FIG. 4 illustrates an exemplary embodiment of a table storing information on logical units.

FIG. 5 illustrates an exemplary embodiment of a disk drive threshold.

FIG. 6 illustrates an exemplary embodiment of a RAID group threshold.

FIG. 7 illustrates an exemplary embodiment of a logical unit threshold.

FIG. 8 illustrates an exemplary embodiment of a process for updating a status of resources in a disk array system.

FIG. 9 illustrates an exemplary embodiment of a process for updating a status of disk drives.

FIG. 10 illustrates an exemplary embodiment of a process for updating a status of RAID groups.

FIG. 11 illustrates an exemplary embodiment of a process for updating a status of logical units.

FIG. 12 illustrates an exemplary embodiment of a method for creating a RAID group.

FIG. 13 illustrates an exemplary embodiment of a method for creating a logical unit.

FIG. 14 illustrates an exemplary embodiment of a method for assigning a logical unit to a port.

FIG. 15 illustrates an exemplary embodiment of a table storing information on a RAID groups.

FIG. 16 illustrates an exemplary embodiment of a table storing information on logical units.

FIG. 17 illustrates an exemplary embodiment of a method for creating a RAID group pool.

FIG. 18 illustrates an exemplary embodiment of a method for creating a virtual LU.

FIG. 19 illustrates an exemplary embodiment of a status update thread in disk array control program in accordance with the second embodiment of the inventive methodology.

FIG. 20 illustrates an exemplary embodiment of an area assignment process in a disk array control program in accordance with the second embodiment of the inventive methodology.

FIG. 21 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

### First Embodiment

1. System Structure

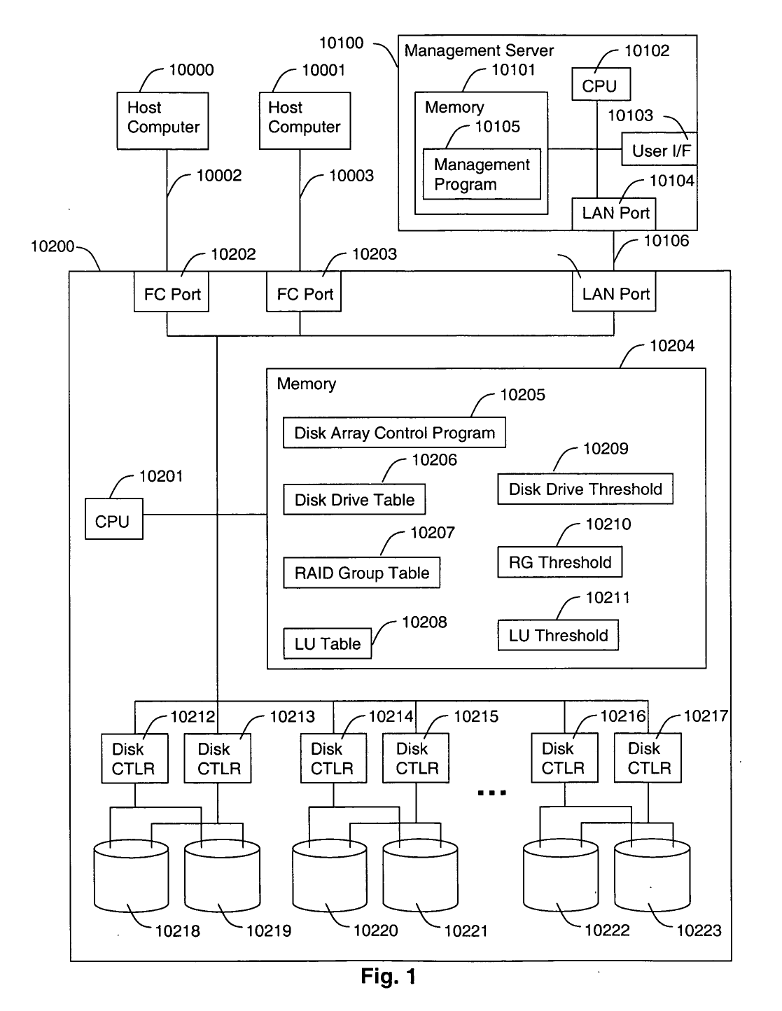

FIG. 1 provides an overview of a computer storage system, which may be used to implement an embodiment of the inventive technique. The components of the storage system shown in FIG. 1 are described in detail below.

(1) Host computers 10000 and 10001 are connected to a disk array system 10200 via FC (FibreChannel) cables 10002 and 10003, respectively. The host computers access the data stored in logical units (LUs) provided by the disk arrays of the system 10200.

(2) The disk array system 10200 is controlled by an administrator from a management server 10100. The management server may include a CPU 10102, which executes Management Program 10105 stored in its memory 10101. The Management Program enables the management server to communicate with the administrator through a user interface 10103 and with the disk array system 10200 through a LAN port 10104. The LAN port 10104 is connected to the disk array system 10200 via a LAN cable 10106.

(3) The disk array system 10200 includes FC ports 10202 and 10203 and LAN port 10224, which enable the disk array system to communicate with the host computers and the management server, respectively.

(4) The disk array system 10200 further includes disk drives 10218-10223, which are being accessed through disk controllers 10212-10217. Each disk drive is simultaneously connected to two disk controllers in such a way that the disk drive may be accessed even if one of the disk drive controllers fails.

(5) A CPU 10201 executes Storage Control Program 10205, which is stored in a memory 20204. The Storage Control Program processes I/O requests sent from the host computers 10000 and 10001, detects failures, manages resource allocation, and communicates with the management console.

(6) The memory 10204 stores a Disk Drive Table 10206, which contains information about disk drives in the disk array system 10200, a RAID Group Table 10207, which contain information about RAID groups, and an LU Table 10208, which contains information about LUs within the disk array system 10200.

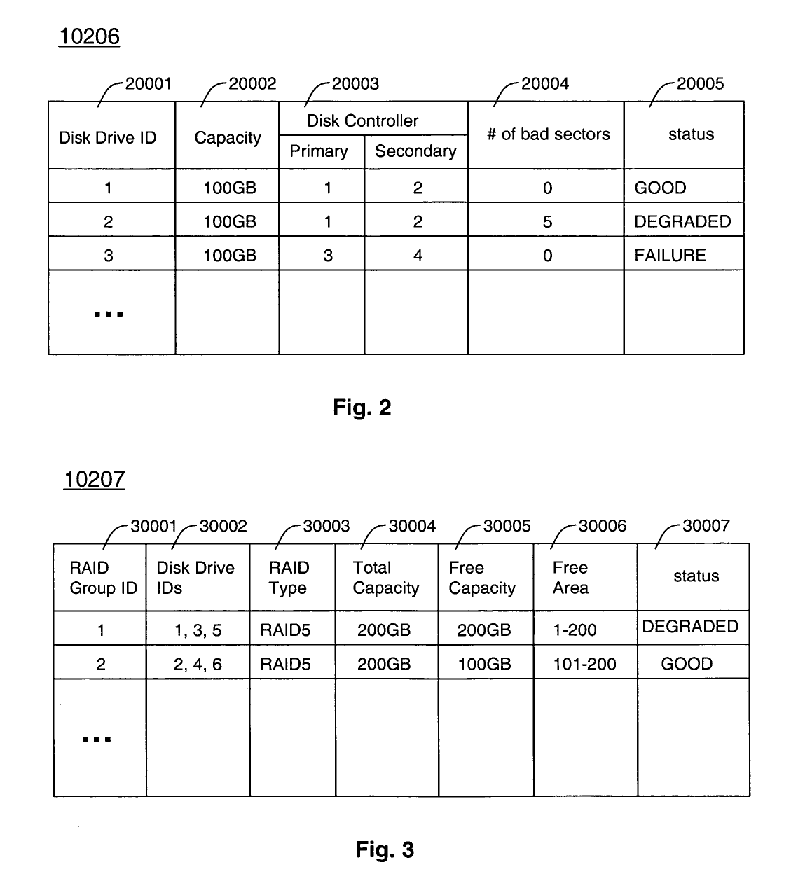

(A) As shown in FIG. 2, for each disk drive, the Disk Drive Table 10206 lists the Disk Drive ID, disk drive capacity, primary and secondary disk drive controllers, which are connected to the drive, numbers of bad sectors in the drive, and the current status of the drive. The information in the table 10206 is updated upon the change of status of any of the listed disk drives, or periodically, upon the passage of a predetermined time interval.

(B) As shown in FIG. 3, for each RAID group, RAID Group Table lists the RAID Group ID, the IDs of all disk drives, which compose the RAID group, RAID Type, capacity, free capacity, free area, and current status of the RAID group.

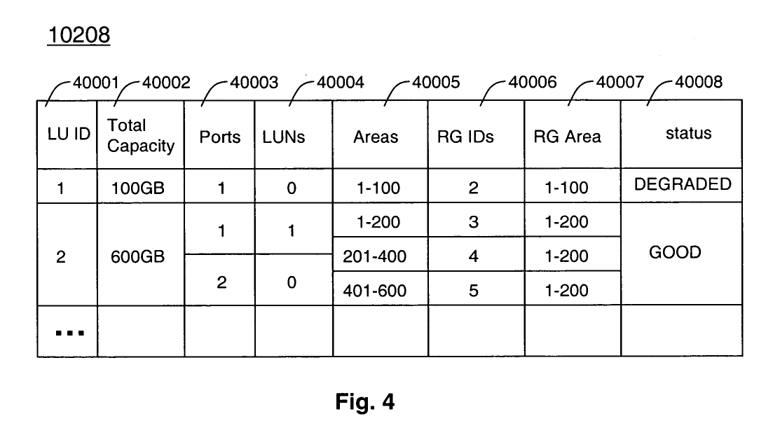

(C) As shown in FIG. 4, for each LU, the LU Table contains LU ID, capacity, ports to which the LU assigned, LUN (Logical Unit Number) which assigned to the LU for the port, areas of LU, ID and areas of RAID groups which are assigned to the areas of the LU, and the current status of the RAID group.

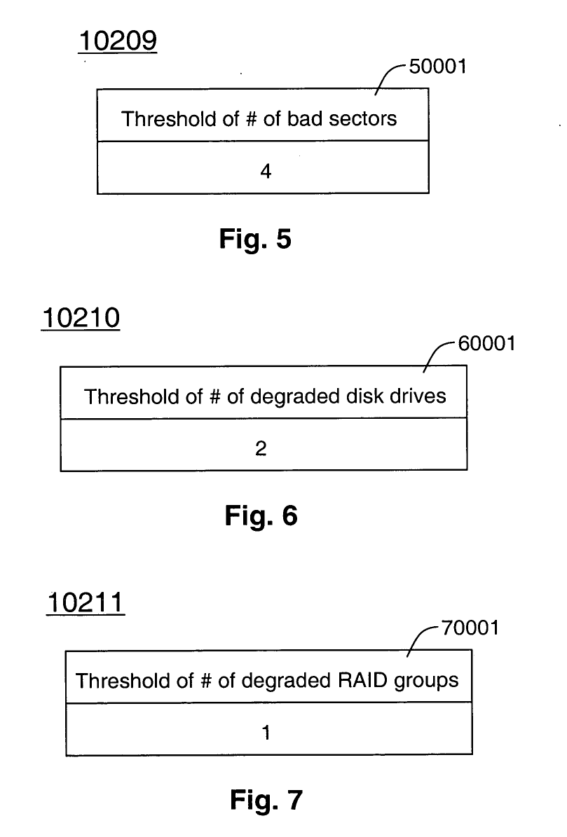

(D) Disk Drive Threshold 10209, RAID Group Threshold 10210, and LU Threshold 10211 storage areas contain threshold values for disk drives, RAID groups, and LUs, respectively. Those thresholds are illustrated in FIG. 5 (element 50001), FIG. 6 (element 60001) and FIG. 7 (element 70001), respectively. The Disk Array Control Program 10205 determines that a resource is healthy if the number of failures in the resource is less than the threshold value.

2. Managing Tables

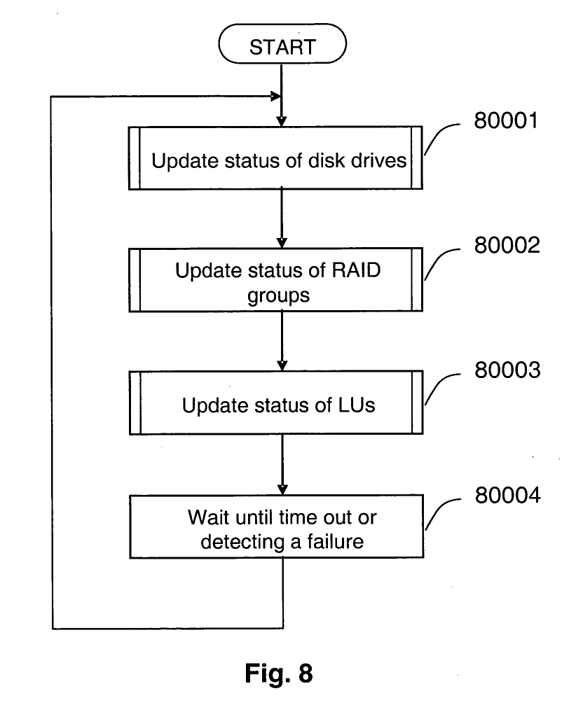

FIG. 8 illustrates an exemplary process flow of the Disk Array Control Program, which updates the status of resources in the tables. Specifically, the aforesaid program sequentially updates the status of the disk drives, RAID groups, and LUs, see steps 80001-80003 of FIG. 8. At step 80004, the program awaits until the predefined time period expires or until a failure is detected, whereupon the steps described hereinbefore are repeated.

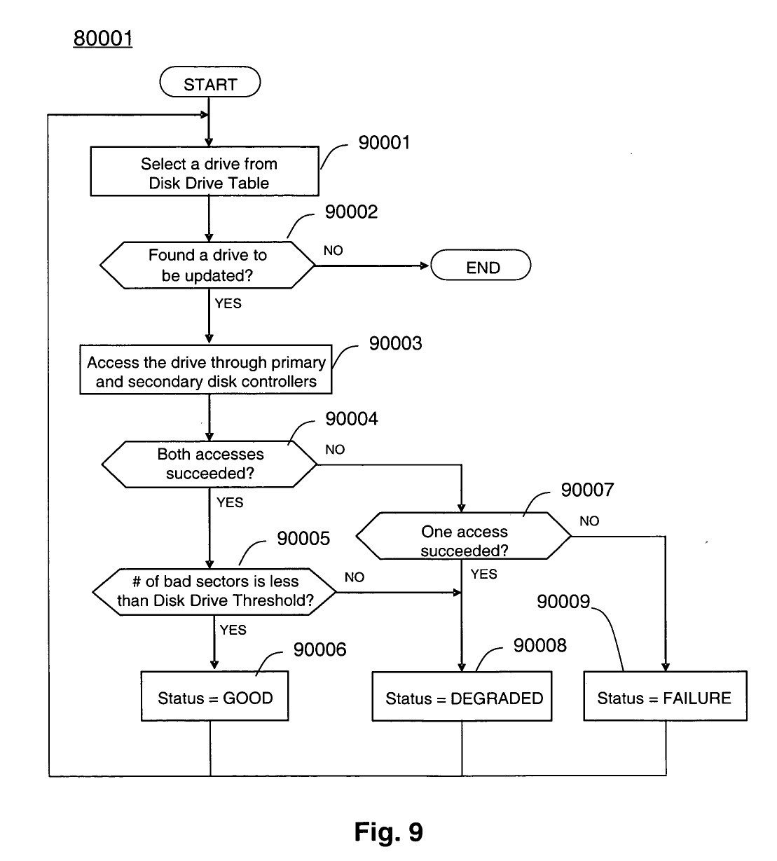

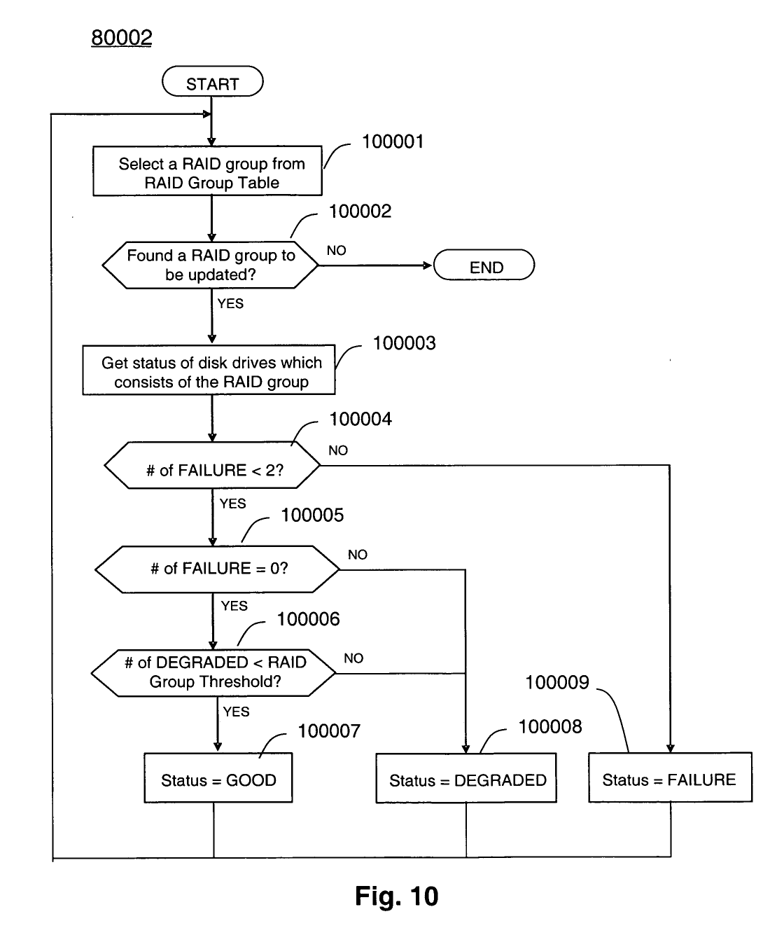

Details of the step 80001 of the process shown in FIG. 8 (updating the status of the disk drives) is shown in FIG. 9. The Disk Array Control Program selects a disk drive from the Disk Drive Table in step 90001. If the processing of all drives has already been completed, the process finishes at step 90002. Otherwise, the program attempts to access the selected drives via the primary and the secondary disk controllers (see step 90003). If both access attempts succeeded, the program determines that both of the disk controllers are healthy and the operation proceeds to step 90005. At step 90005, the program obtains the number of bad sectors in the drive. This number can be obtained by, for example, issuing a standard command to the drive. If the determined number of the bad sectors is smaller than the appropriate Disk Drive Threshold, the status of the drive is set to GOOD. If only one of the two access attempts to the drive has succeeded (step 90007), that is, if one of the attached disk drive controllers failed, or if the number of bad sectors is equal to or greater than the threshold value, the status of the drive is set to DEGRADED. The drive status DEGRADED means that the corresponding disk drive is available but not healthy. If both of access attempts have failed, the status of the drive is set to FAILURE, which indicates that the drive is not available.

Details of the step 80002, which involves updating of the status of the RAID groups, are shown in FIG. 10. For each selected RAID group (step 100001 and step 10002), the Disk Array Control Program obtains the status of all disk drives, which compose the selected RAID group (step 100003). If, for any one RAID group, the number of drives with FAILURE status is equal to or greater than 2 (step 100004), which means data in RAID group of RAID 5 is lost, the status of the RAID group is set to FAILURE (step 100009). If the number of drives with the FAILURE status is equal to 0 (step 100005) and the number of drives with DEGRADED status is less than the RAID Group Threshold (step 100006), the status of the RAID group is set to GOOD (step 100007). Otherwise, the status of the RAID group is set to DEGRADED (step 100008), which indicates that one of disk drives fails or a number of disk drives are degraded.

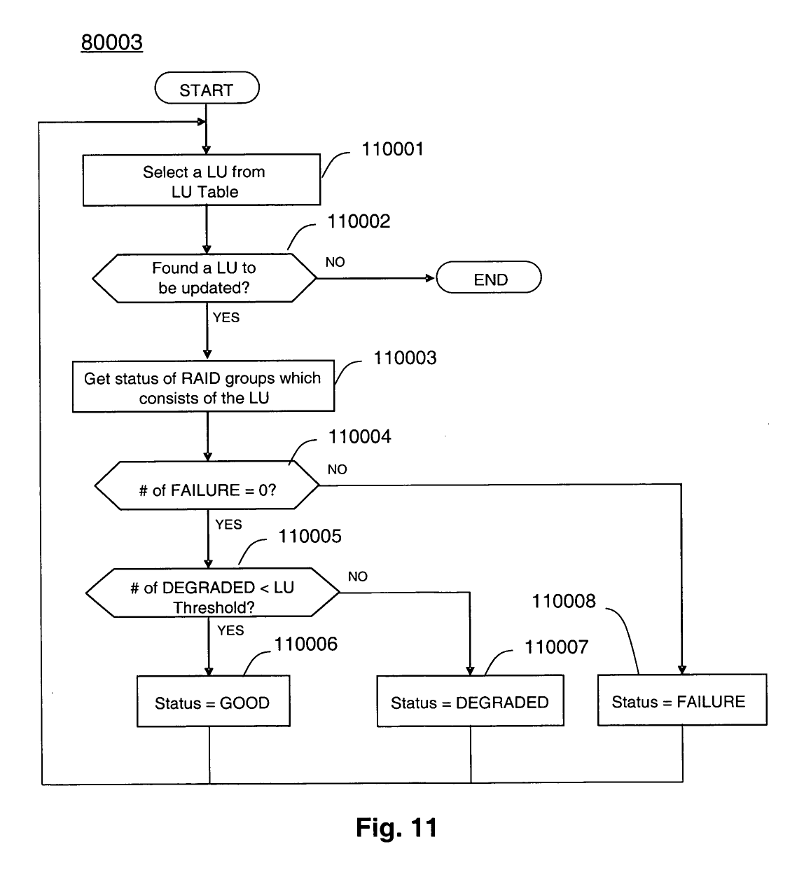

Details of the step 80003, which involves updating the status of LUs, is shown in FIG. 11. As in the case of updating the status of RAID groups, described above, Disk Array Control Program updates the status of each LU by determining the status of all RAID groups, which compose that LU (step 110003). In this case, if one of RAID groups fails (step 110004), data is lost and the status of the LU is set to FAILURE (step 110008).

As described above, status of each resource is determined by the status of all resources, which compose the parent resource. If the data stored in the resource cannot be accessed, the status is set to FAILURE. If the number of resources having DEGRADED status is smaller than the predetermined threshold, the status of the parent resource is set to GOOD. Otherwise, the status is set to DEGRADED.

3. Selecting Resources

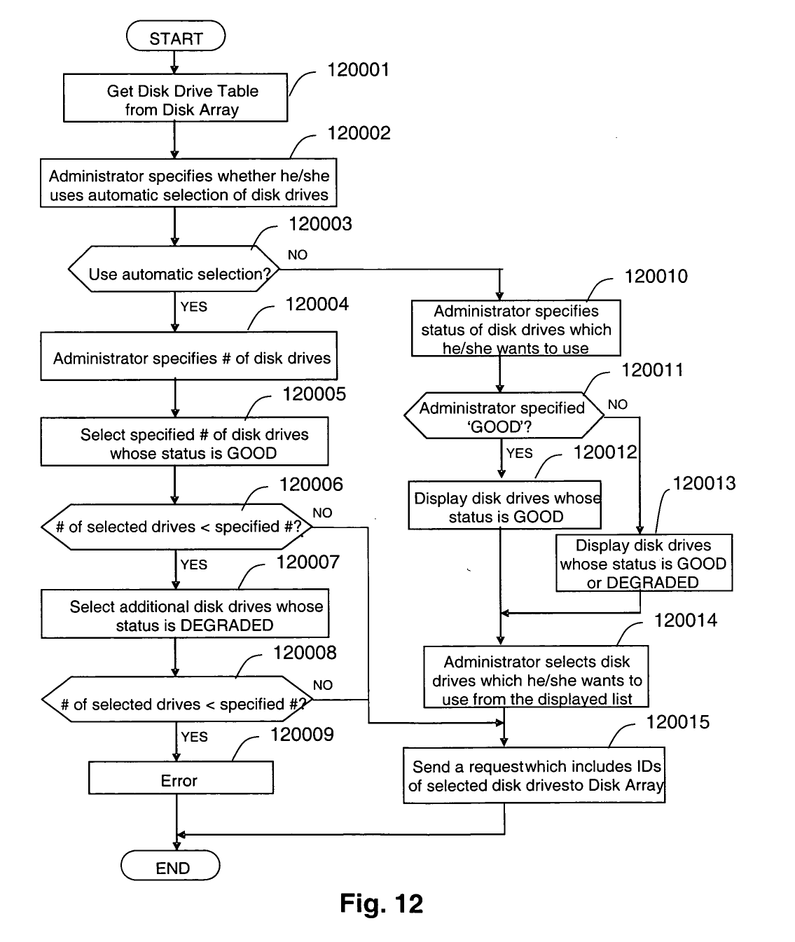

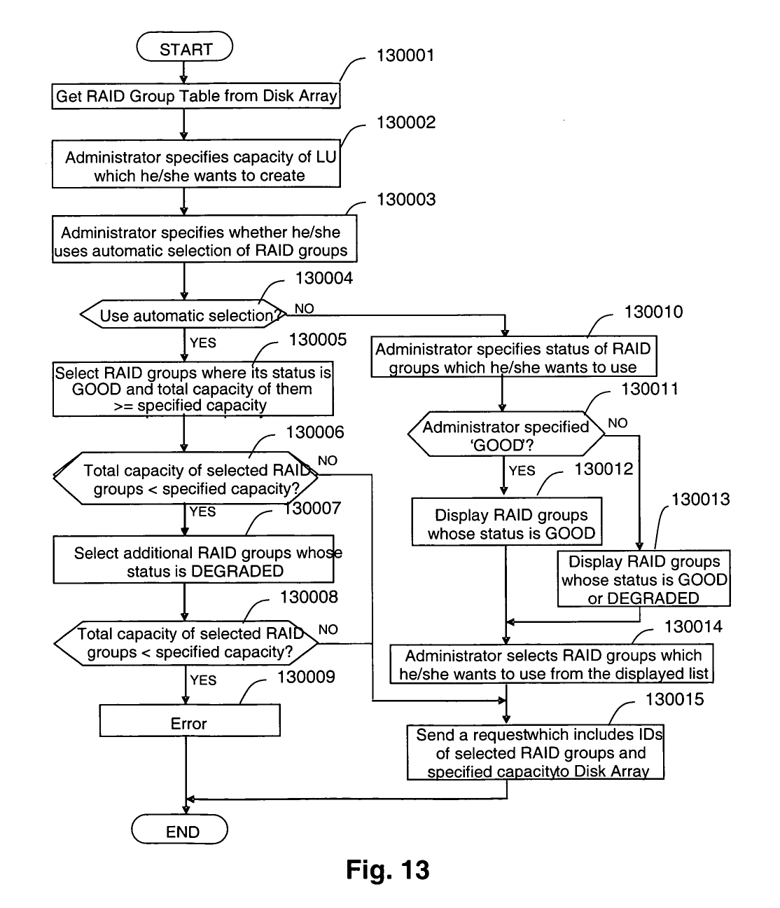

FIG. 12 illustrates a process flow of the Management Program 10105, which is operable to create a RAID group. If an administrator directs the program to create a RAID group, the program first obtains the Disk Drive Table from the disk array system (step 120001). Next, the administrator specifies whether he/she allows the program to automatically select disk drives to compose the RAID group (step 120002). If the administrator opts for the automatic selection (step 120003), the program prompts the administrator to specify the number of the disk drives to use (step 120004), whereupon the program selects the specified number of disk drives whose status is GOOD (step 120005). If the program cannot find sufficient number of disk drives (step 120006), it selects additional disk drives having DEGRADED status (step 120007). If the program still cannot find sufficient number of disk drives (step 120008), it displays an error message and terminates the process (step 120009). If the administrator specifies manual operation, the program allows the administrator to manually specify the status of disk drives, which he/she wants to use (step 120010). If only the GOOD status is specified (step 120011), the program displays a list of disk drives having GOOD status (step 120012). Otherwise, the program displays a list of disk drives with GOOD or DEGRADED status (step 120013). The administrator then selects the specific disk drives, which he/she wants to use from the displayed list (step 120014). Finally, the program issues a request containing the IDs of the selected disk drives to disk array system. Upon receiving this request, the Disk Array Control Program creates a RAID group and updates the appropriate RAID Group Table.

FIG. 13 illustrates a process flow of a Management Program, operable to create an LU. If an administrator directs the aforesaid program to create an LU, the program obtains the RAID Group Table from disk array system (step 130001). Next, the administrator specifies the desired capacity of the LU, which he/she wants to create (step 130002), and specifies whether he/she allows the program to automatically select RAID groups to compose the target LU (step 130003). If the administrator opts for the automatic selection (step 130004), the program selects RAID groups, each having the GOOD status and the aggregate capacity equal to or greater than the desired capacity specified by the administrator (step 130005). If the Management Program cannot find GOOD RAID groups of sufficient capacity (step 130006), it selects additional RAID groups with the DEGRADED status (step 130007). If the program still cannot find sufficient RAID groups (step 130008), it displays an error message and terminates its operation (step 130009). If the administrator selects the manual operation, the program displays a list of RAID groups, which have the status specified by the administrator. The administrator then selects RAID groups from the displayed list (step 130010-130014). Finally, the Management Program sends a request, which includes IDs of the selected RAID groups and the specified capacity of the LU to disk array system 10200. After receiving the request, the Disk Array Control Program 10205 creates an LU by allocating storage areas from the specified RAID groups and updates the LU Table and RAID Group Table accordingly.

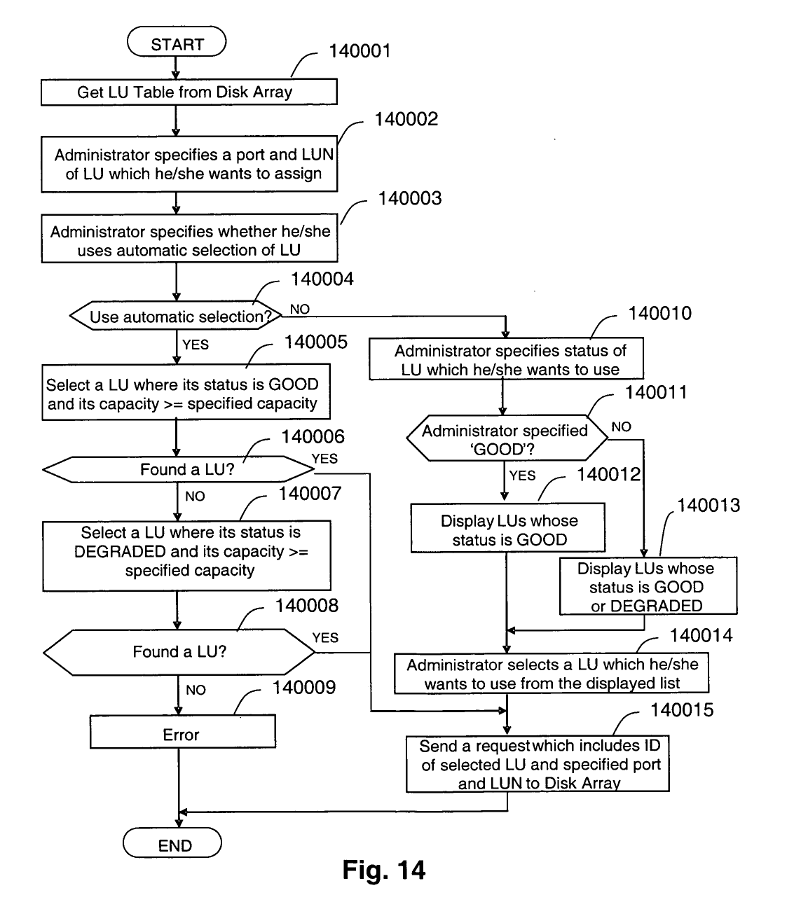

FIG. 14 illustrates an exemplary process flow of an embodiment of the inventive Management Program operable to assign an LU to a port. As in the process flows shown in FIGS. 12 and 13, the Management Program preferably selects or displays LUs having the GOOD status.

By using the inventive processes described hereinabove, implemented in accordance with the inventive concept, healthy resources are preferentially used to increase reliability and availability of data in the storage system.

### Second Embodiment

4. Reallocation of Resources in Thin-provisioning Storage System

In this embodiment of the inventive concept, not all areas of LUs are assigned. Instead, VLUs (Virtual LUs) are created and the actual areas are assigned from the available RAID groups specified in advance when a host computer actually stores data into those areas. This technique is known as Thin-provisioning. In this configuration, an additional table called RAID Group Pool Table is used to specify which RAID groups are used for which VLUs.

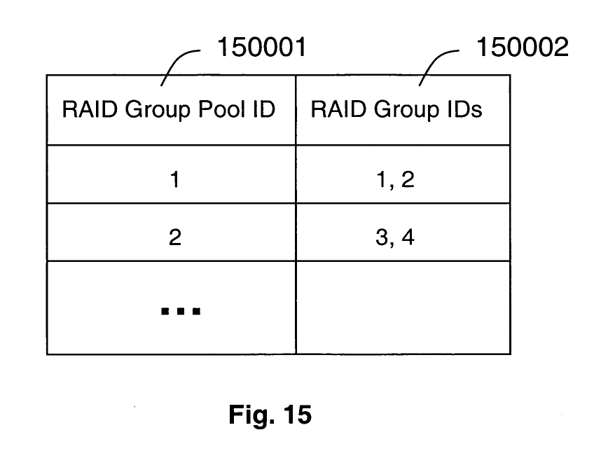

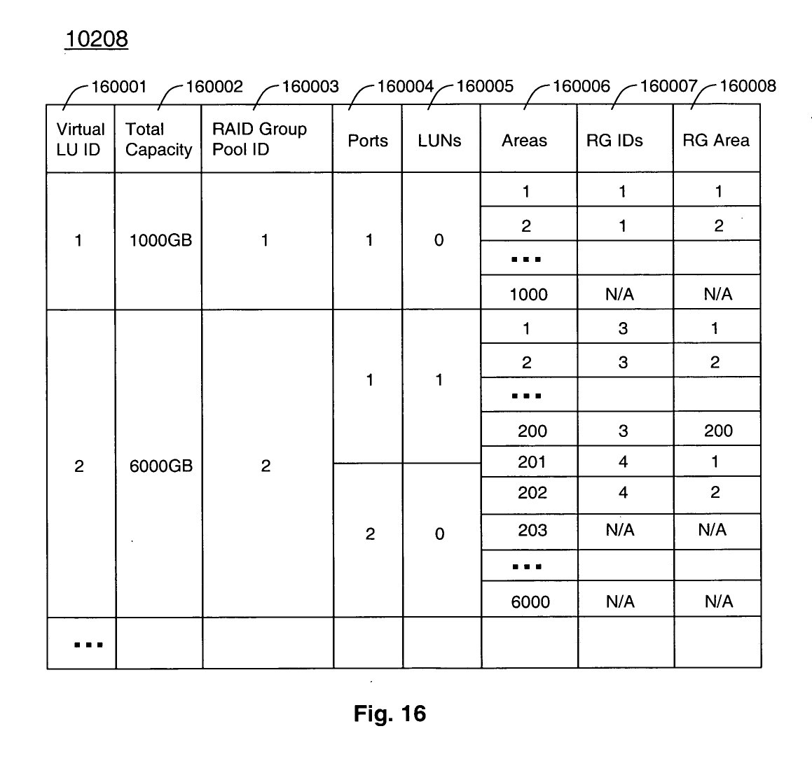

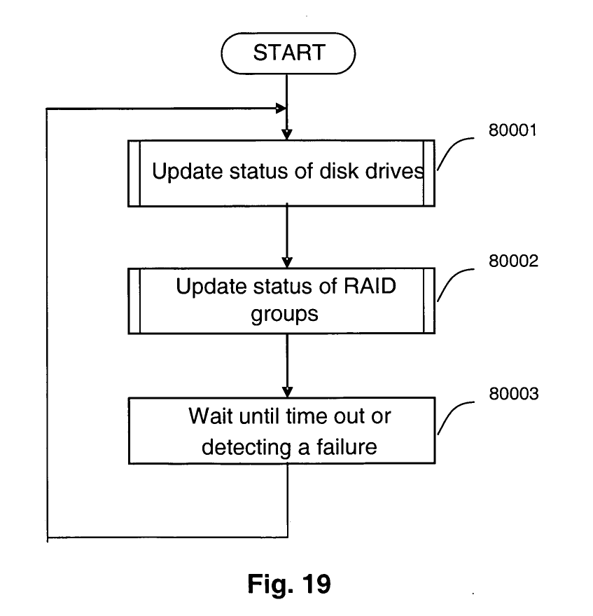

FIG. 15 illustrates an exemplary embodiment of the RAID Group Pool Table. For each RAID Group pool, the table contains ID and RAID groups, which compose the RAID Group Pool. LU Table of this embodiment is shown in FIG. 16. For each VLU 160001, the table lists the corresponding RAID Group Pool ID (160003) as well as the total capacity (160002), FC port (160004) and LUN (160005) of the VLU. For each area in each VLU, the table contains IDs and areas of the assigned RAID groups (160006-160008). If the actual RAID group area has not yet been assigned to the VLU area, RAID Group ID is set to N/A. The process flow of the Disk Array Control Program operable to update the status of the resources is modified as shown in FIG. 19 because the VLU has no status. Specifically, steps 80001, 80002 and 80004 of the process flow shown in FIG. 19 are equivalent to the corresponding steps of the process flow shown in FIG. 8. However, the step 80003, which involves updating the status of the LU, is eliminated for the reason stated above.

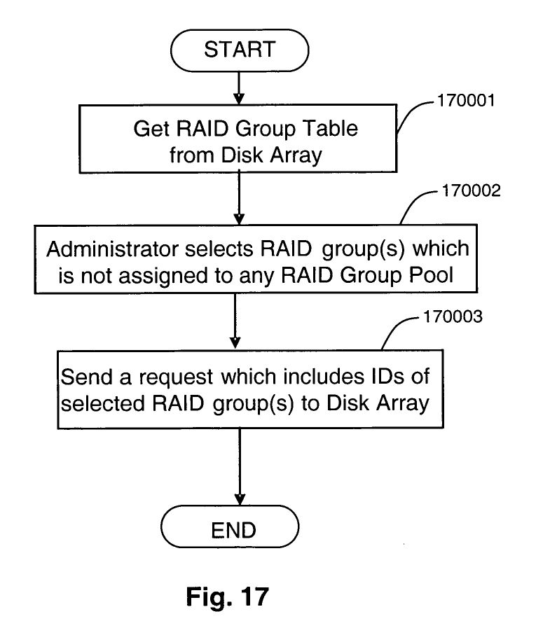

FIG. 17 illustrates the process flow of the Management Program operable to create a RAID group pool. If an administrator directs the program to create a RAID group pool, the program obtains the RAID Group Table from the disk array system (step 170001). Next, the administrator selects RAID group(s), which are not assigned to any RAID group pools (step 170002) and the program issues a request, which includes IDs of the selected RAID group(s), to the disk array system 10200 (step 170003). After receiving the request, the Disk Array Control Program creates a RAID group pool by updating the RAID Group Pool Table.

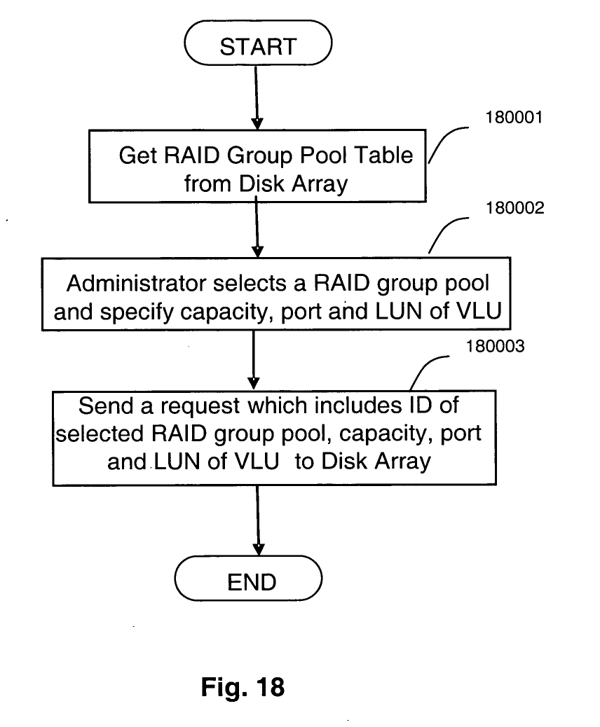

FIG. 18 illustrates the process flow of the Management Program operable to create a VLU. If an administrator directs it to create a VLU, it gets RAID Group Pool Table from disk array system (step 180001). Next, the administrator selects a RAID group pool and specifies the capacity, port and LUN of VLU (step 180002). After that, the program issues a request, which includes the selected parameters, to the disk array system (step 180003). After receiving the request, the Disk Array Control Program creates the VLU and updates the appropriate VLU Table.

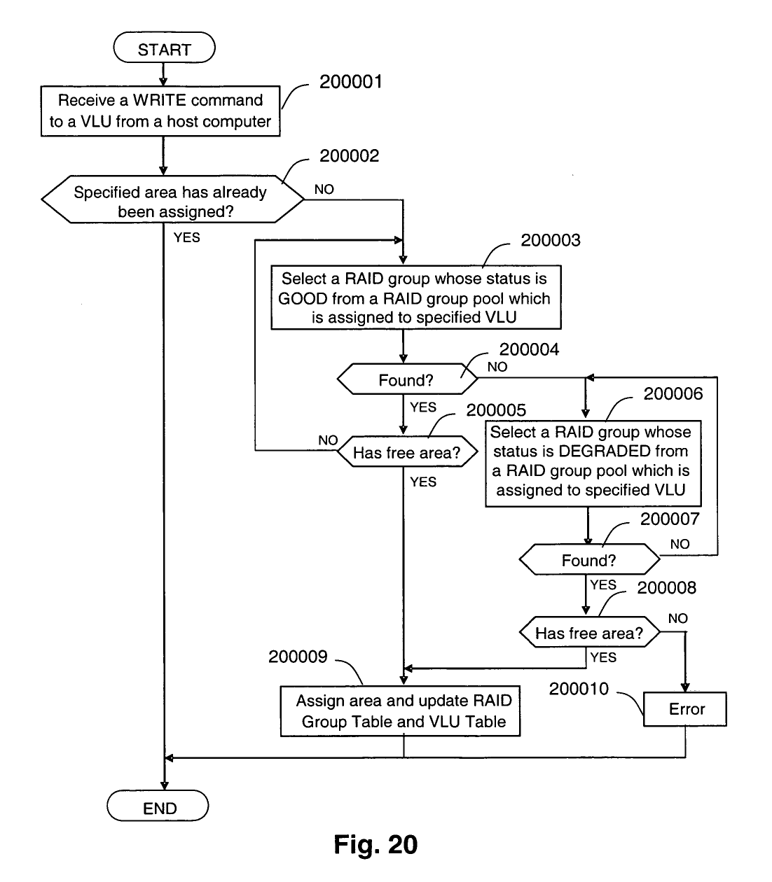

In this embodiment, as shown in FIG. 20, the actual storage area is assigned to a VLU when the host computer actually stores data into the area (step 200001). At step 200002, the program verifies whether the specified area has already been assigned. If so, the program terminates. If the area is unassigned, as shown in FIG. 20, the area to be assigned is selected by the Disk Array Control Program, which sequentially selects RAID groups with GOOD status from the RAID group pool (steps 200003 and 200004). If there are no RAID groups with GOOD status in the RAID group pool associated with the VLU or if all of the GOOD RAID groups have no available free space, the program assigns to VLU areas from RAID groups with DEGRADED status, if any such areas are found (steps 200005, 200006 and 200007). If no space is available in both GOOD and DEGRADED RAID groups, the program returns error (step 200008, 200010). If the appropriate area is found, it is assigned to the VLU and the appropriate VLU Table is updated accordingly (step 200009).

By using the inventive systems and processes described hereinabove, healthy resources are preferentially used to increase reliability and availability of data in the thin-provisioning storage system.

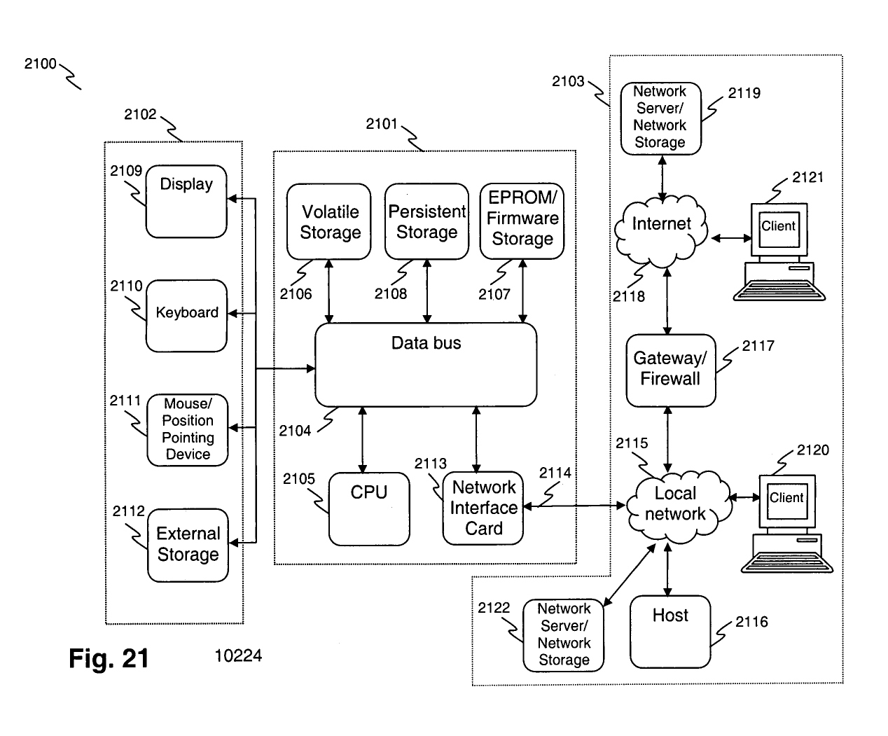

FIG. 21 is a block diagram that illustrates an embodiment of a computer/server system 2100 upon which an embodiment of the inventive methodology may be implemented. The system 2100 includes a computer/server platform 2101, peripheral devices 2102 and network resources 2103.

The computer platform 2101 may include a data bus 2104 or other communication mechanism for communicating information across and among various parts of the computer platform 2101, and a processor 2105 coupled with bus 2104 for processing information and performing other computational and control tasks. Computer platform 2101 also includes a volatile storage 2106, such as a random access memory (RAM) or other dynamic storage device, coupled to bus 2104 for storing various information as well as instructions to be executed by processor 2105. The volatile storage 2106 also may be used for storing temporary variables or other intermediate information during execution of instructions by processor 2105. Computer platform 2101 may further include a read only memory (ROM or EPROM) 2107 or other static storage device coupled to bus 2104 for storing static information and instructions for processor 2105, such as basic input-output system (BIOS), as well as various system configuration parameters. A persistent storage device 2108, such as a magnetic disk, optical disk, or solid-state flash memory device is provided and coupled to bus 2101 for storing information and instructions.

Computer platform 2101 may be coupled via bus 2104 to a display 2109, such as a cathode ray tube (CRT), plasma display, or a liquid crystal display (LCD), for displaying information to a system administrator or user of the computer platform 2101. An input device 2110, including alphanumeric and other keys, is coupled to bus 2104 for communicating information and command selections to processor 2105. Another type of user input device is cursor control device 2111, such as a mouse, a trackball, or cursor direction keys for communicating direction information and command selections to processor 2105 and for controlling cursor movement on display 2109. This input device typically has two degrees of freedom in two axes, a first axis (e.g., x) and a second axis (e.g., y), that allows the device to specify positions in a plane.

An external storage device 2112 may be connected to the computer platform 2101 via bus 2104 to provide an extra or removable storage capacity for the computer platform 2101. In an embodiment of the computer system 2100, the external removable storage device 2112 may be used to facilitate exchange of data with other computer systems.

The invention is related to the use of computer system 2100 for implementing the techniques described herein. In an embodiment, the inventive system may reside on a machine such as computer platform 2101. According to one embodiment of the invention, the techniques described herein are performed by computer system 2100 in response to processor 2105 executing one or more sequences of one or more instructions contained in the volatile memory 2106. Such instructions may be read into volatile memory 2106 from another computer-readable medium, such as persistent storage device 2108. Execution of the sequences of instructions contained in the volatile memory 2106 causes processor 2105 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 2105 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 2108. Volatile media includes dynamic memory, such as volatile storage 2106. Transmission media includes coaxial cables, copper wire and fiber optics, including the wires that comprise data bus 2104. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 2105 for execution. For example, the instructions may initially be carried on a magnetic disk from a remote computer. Alternatively, a remote computer can load the instructions into its dynamic memory and send the instructions over a telephone line using a modem. A modem local to computer system 2100 can receive the data on the telephone line and use an infra-red transmitter to convert the data to an infra-red signal. An infra-red detector can receive the data carried in the infra-red signal and appropriate circuitry can place the data on the data bus 2104. The bus 2104 carries the data to the volatile storage 2106, from which processor 2105 retrieves and executes the instructions. The instructions received by the volatile memory 2106 may optionally be stored on persistent storage device 2108 either before or after execution by processor 2105. The instructions may also be downloaded into the computer platform 2101 via Internet using a variety of network data communication protocols well known in the art.

The computer platform 2101 also includes a communication interface, such as network interface card 2113 coupled to the data bus 2104. Communication interface 2113 provides a two-way data communication coupling to a network link 2114 that is connected to a local network 2115. For example, communication interface 2113 may be an integrated services digital network (ISDN) card or a modem to provide a data communication connection to a corresponding type of telephone line. As another example, communication interface 2113 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 2113 sends and receives electrical, electromagnetic or optical signals that carry digital data streams representing various types of information.

Network link 2113 typically provides data communication through one or more networks to other network resources. For example, network link 2114 may provide a connection through local network 2115 to a host computer 2116, or a network storage/server 2122. Additionally or alternatively, the network link 2114 may connect through gateway/firewall 2117 to the wide-area or global network 2118, such as an Internet. Thus, the computer platform 2101 can access network resources located anywhere on the Internet 2118, such as a remote network storage/server 2119. On the other hand, the computer platform 2101 may also be accessed by clients located anywhere on the local area network 2115 and/or the Internet 2118. The network clients 2120 and 2121 may themselves be implemented based on the computer platform similar to the platform 2101.

Local network 2115 and the Internet 2118 both use electrical, electromagnetic or optical signals that carry digital data streams. The signals through the various networks and the signals on network link 2114 and through communication interface 2113, which carry the digital data to and from computer platform 2101, are exemplary forms of carrier waves transporting the information.

Computer platform 2101 can send messages and receive data, including program code, through the variety of network(s) including Internet 2118 and LAN 2115, network link 2114 and communication interface 2113. In the Internet example, when the system 2101 acts as a network server, it might transmit a requested code or data for an application program running on client(s) 2120 and/or 2121 through Internet 2118, gateway/firewall 2117, local area network 2115 and communication interface 2113. Similarly, it may receive code from other network resources.

The received code may be executed by processor 2105 as it is received, and/or stored in persistent or volatile storage devices 2108 and 2106, respectively, or other non-volatile storage for later execution. In this manner, computer system 2101 may obtain application code in the form of a carrier wave.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the computerized storage system with data replication functionality. It is intended that the specification and examples be considered as exemplary only, with a true scope and spirit of the invention being indicated by the following claims.

What is claimed is:

1. A method for selecting resources for inclusion into a resource group, the method comprising:
a. Receiving information from a user on an amount of required resources;
b. Determining whether the required amount of resources having a good status is available.
c. If the required amount of resources having the good status is available, selecting the required amount of resources having the good status;
d. If the required amount of resources having the good status is not available, verifying whether the required amount of resources having either the good or a degraded status is available;
e. If the required amount of resources having either the good or the degraded status is available, selecting all resources having the good status and an additional amount of resources having the degraded status and including the selected resources to the resource group.

2. The method of claim 1, wherein the resources are disk drives, the amount of resources is a number of the disk drives and the resource group is a RAID group.

3. The method of claim 2, wherein the status of a disk drive is good when the disk drive may be accessed both through a primary and through a secondary controller and the status of the disk drive is degraded is the drive may be accessed through only one of the primary or the secondary controller.

4. The method of claim 2, wherein the status of a disk drive is good when a number of bad sectors within the disk drive does not exceed a predetermined threshold.

5. The method of claim 1, wherein the resources are RAID groups, the amount of resources is a capacity of RAID groups and the resource group is a logical storage unit (LU).

6. The method of claim 5, wherein the status of a RAID group is good when the RAID group does not comprise any failed disk drives and when a number of degraded disk drives within the RAID group is smaller than a first predetermined threshold and the status of the RAID group is degraded when either a number of failed disk drives within the RAID group greater than zero but smaller than a second predetermined threshold or a number of degraded disk drives within the RAID group is greater than the first predetermined threshold.

7. The method of claim 6, wherein the status of the LU is good when the LU does not comprise any failed RAID groups and when a number of degraded RAID groups within the LU is smaller than a third predetermined threshold and the status of the LU is degraded when either a number of failed RAID groups within the LU greater than zero but smaller than a fourth predetermined threshold or a number of degraded RAID groups within the LU is greater than the third predetermined threshold.

8. The method of claim 1, further comprising updating the status of the resources.

9. The method of claim 8, wherein the status of the resources is updated periodically, upon passage of a predetermined time interval.

10. The method of claim 8, wherein the status of the resources is updated upon a resource status change.

11. The method of claim 8, further comprising storing the status of the resources is a resource status table.

12. A computerized storage system comprising:
a. a host computer;
b. disk array system coupled to the host computer via a network, and hosting at least one logical unit accessible by the host computer, the disk array system comprising:
i. at least one storage disk drive;
ii. at least two disk drive controllers, each connected to the at least one disk drive;
c. a management server comprising a management console, the management server operable to receive storage system management instructions from an administrator and further operable to execute a management program;
d. a memory unit operable to store a storage control program, a disk drive table comprising information on the at least one storage disk drive, RAID group table comprising information on RAID groups and a LU table comprising information about the at least one logical unit; and
e. a central processing unit operable to execute the storage control program, wherein the storage control program is operable to process input/output requests sent from the host computer, determine the status of the at least one storage disk drive, allocate the at least one disk drives to a RAID group and communicate with the management console.

13. The computerized storage system of claim 12, wherein the storage control program is configured to assign a good status to the at least one storage disk drive if the at least one storage disk drive can be accessed through both of the at least two disk controllers and does not have a number of bad sectors exceeding a predetermined threshold.

14. The computerized storage system of claim 12, wherein the storage control program is configured to assign a degraded status to the at least one storage disk drive if the at least one storage disk drive can be accessed through only one of the at least two disk controllers or has a number of bad sectors exceeding a predetermined threshold.

15. The computerized storage system of claim 12, wherein the storage control program is configured to assign a failed status to the at least one storage disk drive if the at least one storage disk drive cannot be accessed through any of the at least two disk controllers.

16. The computerized storage system of claim 12, wherein upon the allocation of the at least one disk drives to a RAID group, the storage control program is further operable to:
a. Determine whether the required number of disk drives having a good status is available;
b. If the required number of disk drives having the good status is available, selecting the required number of disk drives having the good status;
C. If the required number of disk drives having the good status is not available, verifying whether the required number of disk drives having either the good or a degraded status is available;
d. If the required number of disk drives having either the good or the degraded status is available, selecting all disk drives having the good status and an additional number of disk drives having the degraded status and allocating the selected disk drives to the RAID group.

17. The computerized storage system of claim 12, wherein the storage control program is operable to allocate RAID groups to the at least one logical unit, and wherein upon the allocation of the RAID groups to the logical unit, the storage control program is further operable to:
a. Determine whether the RAID groups of a required capacity and having a good status are available;
b. If the RAID groups of a required capacity and having the good status are available, selecting the RAID groups of a required capacity and having the good status;
c. If the RAID groups of a required capacity and having the good status are not available, verifying whether the RAID groups of a required capacity and having either the good or a degraded status are available;
d. If the RAID groups of a required capacity and having either the good or the degraded status are available, selecting all RAID groups having the good status and additional RAID groups having the degraded status and allocating the selected RAID groups to the logical unit.

18. A computerized storage system comprising:
a. a host computer;
b. disk array system coupled to the host computer via a network, and hosting at least one logical unit accessible by the host computer, the disk array system comprising:
i. at least one storage disk drive;
ii. at least two disk drive controllers, each connected to the at least one disk drive;
c. a management server comprising a management console, the management server operable to receive storage system management instructions from an administrator and further operable to execute a management program;
d. a memory unit operable to store a storage control program, a disk drive table comprising information on the at least one storage disk drive, RAID group table comprising information on RAID groups and a LU table comprising information about the at least one logical unit; and
e. a central processing unit operable to execute the storage control program, wherein the storage control program is operable to process input/output requests sent from the host computer, determine the status of resources, allocate resources to at least one resource group and communicate with the management console.

19. The computerized storage system of claim 18, wherein the status of resources is one of a group consisting of a good, a degraded and a failure.

20. The computerized storage system of claim 19, wherein upon the allocation of the resources to the resource group, the storage control program is further operable to:
a. Determining whether the required amount of resources having a good status is available.
b. If the required amount of resources having the good status is available, selecting the required amount of resources having the good status;
c. If the required amount of resources having the good status is not available, verifying whether the required amount of resources having either the good or a degraded status is available;
d. If the required amount of resources having either the good or the degraded status is available, selecting all resources having the good status and an additional amount of resources having the degraded status and allocating the selected resources to the resource group.

21. The computerized storage system of claim 18, wherein the storage control program preferentially allocates healthy resources to the resource group.

22. The computerized storage system of claim 18, wherein the determining the status of resources comprises:
a. determining the status of the at least one storage disk drive;
b. determining the status of the at least one RAID group;
c. determining the status of the at least one logical unit; and
d. waiting a predetermined period of time or until a failure occurs and repeating the (a) through (d).

23. The computerized storage system of claim 18, wherein the storage control program is operable to replace unhealthy resources within the resource group with healthier resources and wherein a good resource is healthier than a degraded resource and a degraded resource is healthier than a failed resource.
